(19) United States
(12) Patent Application Publication
(10) Pub. No.: US 2009/0280316 A1
(43) Pub. Date: Nov. 12, 2009

(54) JOINING STRUCTURE AND INSERT-MOLDED COVER USING SAME

(75) Inventors: HAN-MING LEE, Tu-Cheng (TW); CHIH-CHIEN HUNG, Tu-Cheng (TW); HSIANG-SHENG CHOU, Tu-Cheng (TW); CHING-HSIEN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/187,393

(22) Filed: Aug. 7, 2008

(30) Foreign Application Priority Data
May 6, 2008 (CN) 200810301434.X

(51) Int. Cl. B32B 7/00; B05D 5/10; B32B 15/00; B32B 15/08

(52) U.S. Cl. 428/332; 427/207.1; 428/457; 428/458

(57) ABSTRACT

An exemplary joining structure, used for insert-molded covers, includes a metallic portion (131), a plastic portion (132) integrally formed with the metallic portion, and an adhesive film (133) formed between the metallic portion and the plastic portion. The metallic portion and the plastic portion are bonded together by the adhesive film. The present invention also relates an insert-molded cover (10) for electronic devices using the joining structure and a method for manufacturing the insert-molded cover for electronic devices.

### CROSS-REFERENCE TO RELATED APPLICATIONS

This application is related to five co-pending U.S. patent applications, applications Ser. No. 12/171271, Ser. No. [to be advised] (Docket No. US20076), Ser. No. [to be advised] (Docket No. US20236), Ser. No. [to be advised] (Docket No. US20421), Ser. No. [to be advised] (Docket No. US20075), and all entitled “INSERT-MOLDED COVER AND METHOD FOR MANUFACTURING SAME”. In the co-pending applications, the inventors are Han-Ming Lee, Chih-Chien Hung, Hsiang-Sheng Chou and Ching-Hsien Chang. Such applications have the same assignee as the present application and have been concurrently filed herewith. The disclosures of the above identified applications are incorporated herein by reference.

### BACKGROUND OF THE INVENTION

1. Field of the Invention

The present invention relates generally to joining structures, more particularly, to a joining structure for joining a metallic portion and a plastic portion, and an insert-molded cover using the joining structure.

2. Discussion of the Related Art

Electronic devices, such as notebook computers, mobile phones, or personal digital assistants (PDAs), are very popular and widely used. Covers of electronic devices are generally made of two kinds of materials, plastic and metal. Generally, a metallic cover has a nicer appearance and a better surface feeling than a plastic one, thus metallic covers for electronic devices are now becoming more and more popular.

Because the metal has a good electromagnetic shielding capability, a portion of the cover corresponding to an antenna of an electronic device is made of plastic, so that signals can be received and transmitted through the plastic portion, and certain functions would not be weaken by electromagnetic shielding. Generally, the metallic cover includes a metallic body and a plastic antenna lid fixed to the metallic body by hook locking or rivet jointing. However, these fixing means easily leave a gap between the plastic antenna lid and the metallic body, such that the plastic antenna lid easily becomes loosened from the metallic body due to the gap. In addition, a thin metallic cover is susceptible to crack at the junction where the plastic antenna lid is fixed to the metallic body by hook locking or rivet jointing. Therefore, the mechanical strength and durability of the metallic cover is relatively compromised.

What is needed, therefore, is a new joining structure and an insert-molded cover using the joining structure that overcomes the above mentioned disadvantages.

### SUMMARY

In one aspect, a joining structure includes a metallic portion, a plastic portion integrally formed with the metallic portion and an adhesive film positioned between the metallic portion and the plastic portion, the metallic portion and the plastic portion are bonded together by the adhesive film.

In another aspect, an insert-molded cover for electronic devices includes a metallic body, a plastic antenna lid integrally formed with the metallic body, and an adhesive film positioned between the metallic body and the plastic antenna lid, the metallic body and the plastic antenna lid are bonded together by the adhesive film.

In still another aspect, a method for manufacturing an insert-molded cover for electronic devices includes following steps. Firstly, a metallic body is manufactured. Secondly, an adhesive is coated on a surface of the metallic body. Thirdly, the adhesive is solidified to form an adhesive film on the surface of the metallic body. Fourthly, a plastic antenna lid is molded on the adhesive film by insert molding.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present joining structure for joining a metallic portion and a plastic portion, and an insert-molded cover using the joining structure. Moreover, in the drawings, like reference numerals designate corresponding parts throughout the several views.

FIG. 1 is an isometric view of an insert-molded cover of the present invention in accordance with one preferred embodiment.

FIG. 2 is a side cross-sectional view of a joining structure of the insert-molded cover in FIG. 1, taken along the line II-II.

FIG. 3 is a side cross-sectional view, similar to FIG. 2, of a joining structure in accordance with an alternative embodiment of the insert-molded cover in FIG. 1.

FIG. 4 is an electron micrograph of a side cross-sectional of a portion of the insert-molded cover in FIG. 1.

### DETAILED DESCRIPTION OF THE EMBODIMENTS

Reference will now be made to the drawings to describe preferred embodiments of the present joining structure for joining a metallic portion and a plastic portion and insert-molded cover using the joining structure, in detail. The insert-molded cover is used for electronic devices such as notebook computers, and mobile phones.

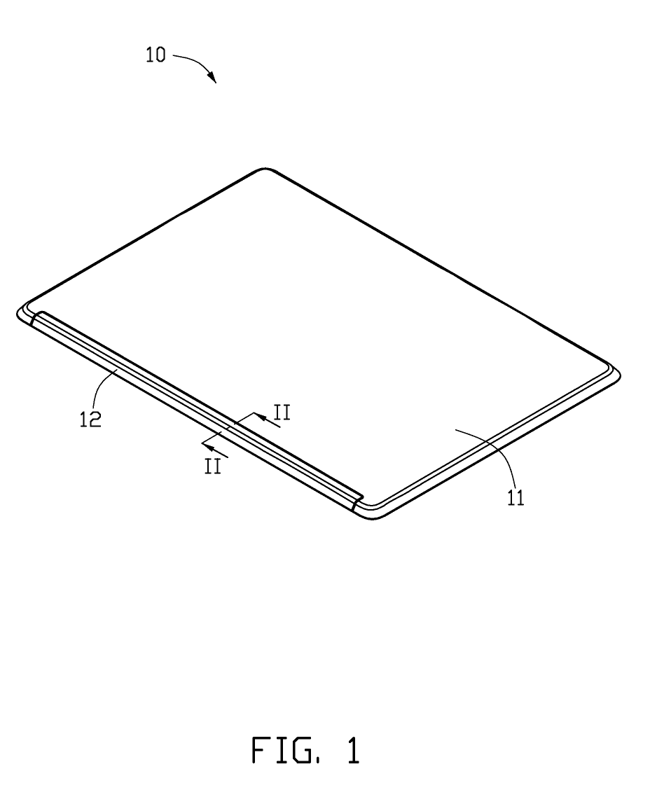

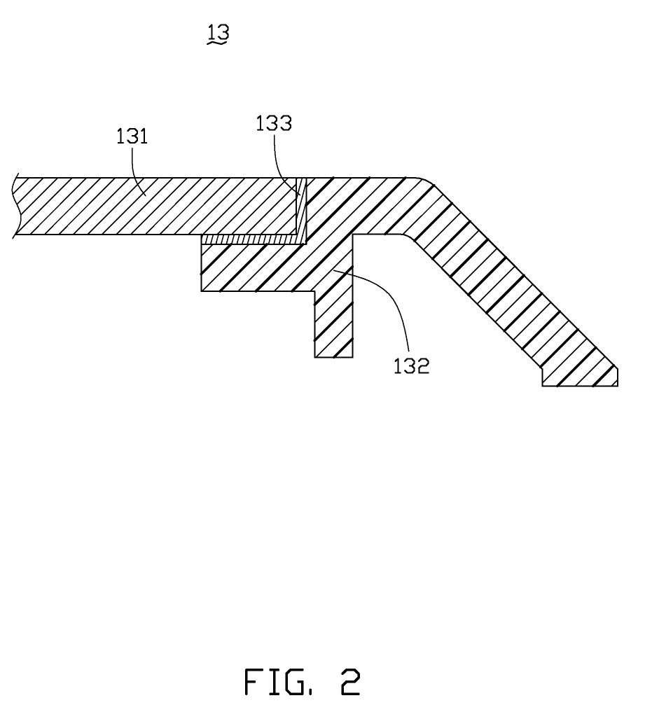

Referring to FIGS. 1 and 2, an insert-molded cover 10 for electronic devices according to a preferred embodiment is shown. The insert-molded cover 10 includes a metallic body 11 and a plastic antenna lid 12. The metallic body 11 and the plastic antenna lid 12 are joined together by a joining structure 13.

The metallic body 11 is substantially a rectangular plate made of alloy, and the alloy is preferably magnesium alloy, aluminum alloy or titanium alloy. In this preferred embodiment, the metallic body 11 is made of magnesium alloy.

The plastic antenna lid 12 is substantially an elongated sheet. The plastic antenna lid 12 is formed on an edge of the metallic body 11. The material of the plastic antenna lid 12 should have a good bonding capability with material of the metallic body 11. In other words, the material of the plastic antenna lid 12 should have a low shrinkage and a similar linear expansion with the material of the metallic body 11. Thus, the material of the plastic antenna lid 12 is selected from the group consisting of liquid crystal polymer (LCP), polyphenylene sulphide (PPS), polybutylene terephthalate (PBT) and their combination.

The joining structure 13 includes a metallic portion 131, a plastic portion 132 and an adhesive film 133 positioned between the metallic portion 131 and the plastic portion 132. In this preferred embodiment, the metallic portion 131 is a portion of the metallic body 11, and the plastic portion 132 is a portion of the plastic antenna lid 12. The adhesive film 133 is positioned between the metallic body 11 and the plastic antenna lid 12.

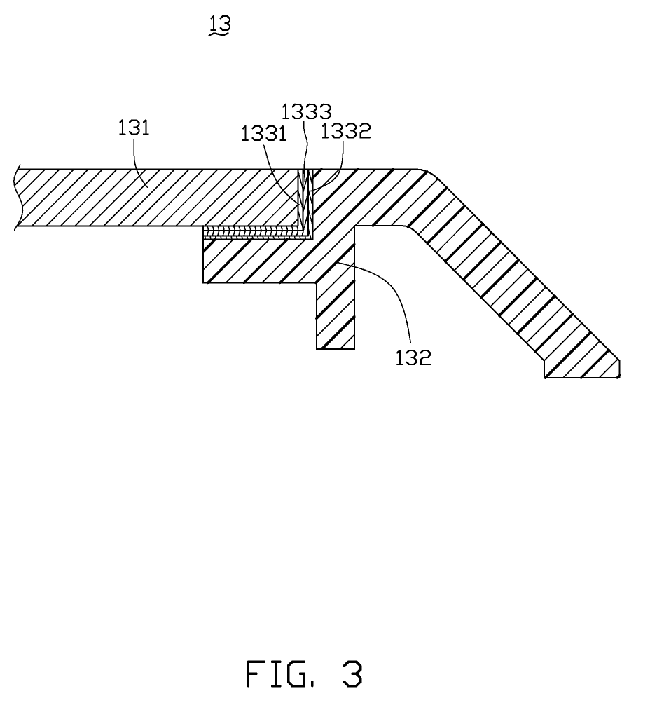

The thickness of the adhesive film 133 is in a range from about 15 microns to about 30 microns. The adhesive film 133 is made of materials including epoxide colophony, polysulphide alcohol, polyamide, black carbon and quaternary amine. Referring to FIG. 3, in an alternative embodiment, the adhesive film 133 may have three layers, and each layer is of different material. A property of a first adhesive layer 1331 adjacent to the metallic portion 131 is configured to have a good bonding ability with the metal, and a property of a second adhesive layer 1332 adjacent to the plastic portion 132 is configured to have a good bonding ability with the plastic. A property of a middle adhesive layer 1333 between the first adhesive layer 1331 and the second adhesive layer 1332 can be a transition layer that is configured to firmly bond the first and second layers 1331, 1332.

A method for manufacturing the insert-molded cover 10 includes following steps.

Firstly, a metallic body 11 is manufactured by casting, forging, or extrusion molding methods.

Secondly, an adhesive is coated on a surface of the metallic body 11. The adhesive can be a light-curing or thermo-curing adhesive. In this preferred embodiment, the adhesive is a thermo-curing adhesive with heat resistance temperature is up to 180° C. The adhesive would be solidified by heating, but the solid adhesive would not be intenerated by heating again. The adhesive is made of materials including epoxide colophony, polysulphide alcohol, polyamide, black carbon and quaternary amine.

Thirdly, the adhesive is solidified to form an adhesive film 133. The adhesive can be solidified by heating, blowing or lighting methods, and the adhesive is preferably solidified by heating. A temperature for heating the adhesive is in a range from about 150° C. to about 200° C., and the temperature for the heating is, preferably, about 180° C. A time period for heating the adhesive is in a range from about 15 minutes to about 30 minutes, and the time period for the heating is, preferably, about 20 minutes.

Fourthly, a plastic antenna lid 12 is molded on the adhesive film 133 by insert molding. In detail, the metallic body 11 is placed into an injection mold as an insert member, then melted plastic is injected into the injection mold. The adhesive film 133 is covered by the melted plastic. Because the materials of the melted plastic and the adhesive film 133 both belong to organic compounds, a good intermolecular force exists between them. Thus, the melted plastic firmly joins with the adhesive film 133 via the intermolecular forces. After the melted plastic is cooled, the plastic antenna lid 12 is achieved and firmly joining with the metallic body 11.

It should be pointed out that, after the first step, the metallic body 11 can be cleaned to remove dusts, oxides or greasy dirt, thus allowing the adhesive to more easier form on the surface of the metallic body 11. In addition, many additive agents can be mixed into the adhesive for improving any characters of the adhesive film 133, such as its glutinosity, heat resistance, or chemic-stability characters.

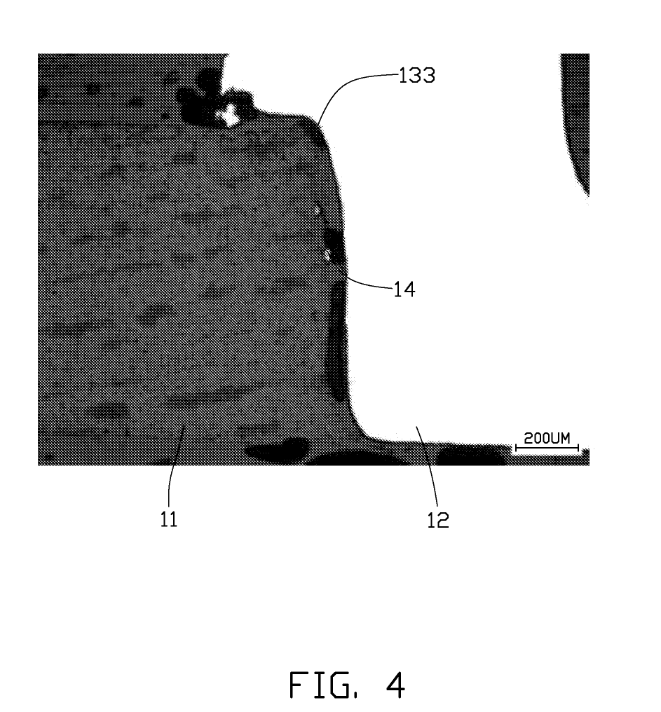

Referring to FIG. 4, it is an electron micrograph of a side cross-sectional of a portion of the insert-molded cover 10. The black area on left side of the electron micrograph is an enlarged view of a portion of the metallic body 11, the white area on right side of the electron micrograph is an enlarged view of a portion of the plastic antenna lid 12, and a transition area between the black area and the white area of the electron micrograph is an enlarged view of a portion of the adhesive film 133. The electron micrograph indicated that, the adhesive film 133 has pores 14 on a surface of the adhesive film 133. When molding the plastic antenna lid 12, the pores 14 of the adhesive film 133 are filled with the melted plastic, thus, after the melted plastic is cooled, the plastic antenna lid 12 and the adhesive film 133 are firmly joined together. Such that, the bonding strength of the metallic body 11 and the plastic antenna lid 12 is enhanced via the adhesive film 133.

It should be understood that, the joining structure 13 can be used in other products, except the insert-molded cover 10, such as stationery, artware and so on.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A joining structure, used for insert-molded covers, comprising:
a metallic portion;
a plastic portion integrally formed with the metallic portion; and
an adhesive film formed between the metallic portion and the plastic portion, wherein the metallic portion and the plastic portion are bonded together by the adhesive film.

2. The joining structure as claimed in claim 1, wherein the adhesive film is made of materials comprising epoxide colophony, polysulphide alcohol, polyamide, black carbon and quaternary amine.

3. The joining structure as claimed in claim 1, wherein the thickness of the adhesive film is in a range from about 15 microns to about 30 microns.

4. The joining structure as claimed in claim 1, wherein the adhesive film have a plurality of layers, and the material of each layer is different.

5. The joining structure as claimed in claim 4, wherein the plurality of layers are three layers; a property of the layer adjacent to the metallic portion is configured to have a good bonding ability with the metal; and a property of the layer adjacent to the plastic portion is configured to have a good bonding ability with the plastic; the middle layer is capable of bonding the two adjacent layers.

6. The joining structure as claimed in claim 1, wherein the material of the plastic portion is a material selected from the group consisting of liquid crystal polymer, polyphenylene sulphide, polybutylene terephthalate and their combination.

7. An insert-molded cover, used for electronic devices, the insert-molded cover comprising:
a metallic body;
a plastic antenna lid integrally formed with the metallic body; and
an adhesive film formed between the metallic body and the plastic antenna lid, wherein the metallic body and the plastic antenna lid are bonded together by the adhesive film.

8. The insert-molded cover as claimed in claim 7, wherein the adhesive film is made of materials comprising epoxide colophony, polysulphide alcohol, polyamide, black carbon and quaternary amine.

9. The insert-molded cover as claimed in claim 7, wherein the thickness of the adhesive film is in a range from about 15 microns to about 30 microns.

10. The insert-molded cover as claimed in claim 7, wherein the adhesive film includes a plurality of layers, and the material of each layer is different; a property of the layer adjacent to the metallic body is configured to have a good bonding ability with the metal, and a property of the layer adjacent to the plastic antenna lid is configured to have a good bonding ability with the plastic.

11. A method for manufacturing an insert-molded cover for electronic devices, comprising:
manufacturing a metallic body;
coating an adhesive on a surface of the metallic body;
solidifying the adhesive to form an adhesive film on the surface of the metallic body; and
molding a plastic antenna lid on the adhesive film by insert molding.

12. The method for manufacturing an insert-molded cover as claimed in claim 11, wherein the adhesive is a thermo-curing adhesive with heat resistance temperature is about 180° C.

13. The method for manufacturing an insert-molded cover as claimed in claim 11, wherein the adhesive is solidified by heating.

14. The method for manufacturing an insert-molded cover as claimed in claim 11, wherein a temperature for the heating is in a range from about 150° C. to about 200° C.

15. The method for manufacturing an insert-molded cover as claimed in claim 13, wherein a period of time for the heating is in a range from about 15 minutes to about 30 minutes.

16. The method for manufacturing an insert-molded cover as claimed in claim 11, further comprising cleaning the metallic body after the manufacturing step.

17. The method for manufacturing an insert-molded cover as claimed in claim 16, wherein the cleaning step removes dusts, oxides or greasy dirt from the metallic body.
